(19) United States
(12) Patent Application Publication
(10) Pub. No.: US 2015/0189176 A1
(43) Pub. Date: Jul. 2, 2015

(54) DOMAIN AWARE CAMERA SYSTEM

(71) Applicant: LYVE MINDS, INC., Cupertino, CA (US)

(72) Inventors: Mihnea Calin Pacurariu, Los Gatos, CA (US); Andreas von Sneidern, San Jose, CA (US); David Hoenig, Cupertino, CA (US)

(73) Assignee: LYVE MINDS, INC., Cupertino, CA (US)

(21) Appl. No.: 14/144,005

(22) Filed: Dec. 30, 2013

(51) Int. Cl. H04N 5/232; H04N 7/18

(52) U.S. Cl. CPC H04N 5/23241; H04N 7/183

(57) ABSTRACT

A camera system is disclosed according to some embodiments described herein that may include a motion sensor 135, an image sensor, a user interface, a memory, and a processor communicatively coupled with at least the motion sensor 135 and the user interface. The processor may be configured to enter a hibernate state; receive motion data from the motion sensor 135; determine whether the motion data indicates motion of the camera system; in the event motion is determined from the motion data, entering a sleep state; receive a user input from the user interface while in the sleep state; and entering an active state such that an image sensor of the camera system is powered on and is actively sampling images.

### FIELD

This disclosure relates generally to a domain aware camera system.

### BACKGROUND

Digital video is becoming as ubiquitous as photographs. The reduction in size and the increase in quality of video sensors have made video cameras more and more accessible for any number of applications. Mobile phones with video cameras are one example of video cameras being more and accessible and usable. Small portable video cameras that are often wearable are another example. The advent of YouTube, Instagram, and other social networks has increased users' ability to share video with others.

### SUMMARY

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

A method for managing power with a camera system is disclosed according to some embodiments described herein. The method includes receiving at a processor motion data from a motion sensor 135 while in a hibernate state; determining, at the processor, whether the motion data indicates motion of the camera system; entering a sleep state in the event the motion data indicates motion of the camera system; receiving a user input while in the sleep state; and entering an active state such that an image sensor of the camera system is powered on and is actively sampling images.

A camera system is disclosed according to some embodiments described herein that may include a motion sensor 135, an image sensor, a user interface, a memory, and a processor communicatively coupled with at least the motion sensor 135 and the user interface. The processor may be configured to enter a hibernate state; receive motion data from the motion sensor 135; determine whether the motion data indicates motion of the camera system; entering a sleep state in the event motion is determined from the motion data; receive a user input from the user interface while in the sleep state; and entering an active state such that an image sensor of the camera system is powered on and is actively sampling images.

A method for managing communication in a camera system is disclosed according to some embodiments described herein. The method may include turning off a Wi-Fi transceiver; receiving, at a processor, global positioning data from a global positioning device; determining, at the processor, whether the global positioning data indicates that the camera system is positioned within a geo-fence; turning on the Wi-Fi transceiver in the event the global positioning data indicates that the camera system is positioned within a geo-fence; and transferring images or video from the camera system to the data hub via Wi-Fi.

According to some embodiments described herein, a camera system may include a global positioning device; an image sensor; a Wi-Fi transceiver; and a processor communicatively coupled with at least the global positioning device and the Wi-Fi transceiver. The image processor may be configured to turn off the Wi-Fi transceiver; receive global positioning data from the global positioning device; determine whether the global positioning data indicates that the camera system is positioned within a geo-fence; turn on the Wi-Fi transceiver; and transfer images or video stored in the memory to a data hub using the Wi-Fi transceiver.

A method for managing communication in a camera system is disclosed according to some embodiments described herein. The method may include turning off a Wi-Fi transceiver; receiving Bluetooth signal data from a Bluetooth transceiver; determining, at the processor, whether the Bluetooth signal indicates that the camera system is within a selected proximity of a data hub; turning on the Wi-Fi transceiver in the event the Bluetooth signal indicates that the Bluetooth signal indicates that the camera system is within a selected proximity of a data hub; and transferring images or video from the camera system to the data hub via Wi-Fi.

According to some embodiments described herein, a camera system may include a Bluetooth transceiver, an image sensor, a Wi-Fi transceiver, and a processor communicatively coupled with at least the Bluetooth transceiver, the image sensor, and the Wi-Fi transceiver. The processor may be configured to turn off the Wi-Fi transceiver; receive a Bluetooth signal data from the Bluetooth transceiver; determine whether the Bluetooth signal indicates that the camera system is within a selected proximity of a data hub; turn on the Wi-Fi transceiver in the event the Bluetooth signal indicates that the camera system is within a selected proximity of a data hub; and transfer images or video to the data hub using the Wi-Fi transceiver.

A method occurring at a camera system is disclosed according to some embodiments described herein. The method may include receiving, at a processor, motion data from a motion sensor 135; determining, at the processor, whether the motion data indicates motion of the camera system; receiving proximity data; determining whether the proximity data indicates that the camera system is positioned within a proximity zone bounding a data hub; turning on the Wi-Fi transceiver; and transferring images or video from the camera system to the data hub via Wi-Fi.

According to some embodiments described herein, a camera system may include a motion sensor 135, a proximity sensor, a Wi-Fi transceiver, an image sensor, and a processor communicatively coupled with at least the motion sensor 135, the proximity sensor, the image sensor, and the Wi-Fi transceiver. The processor may be configured to receive motion data from the motion sensor 135; determine whether the motion data indicates motion of the camera system; receive proximity data from the proximity sensor; determine whether the proximity data indicates that the camera system is positioned within a proximity zone bounding a data hub; turn on the Wi-Fi transceiver; and transfer images or video with the data hub using the Wi-Fi transceiver.

According to some embodiments described herein, in the hibernate state an image sensor of the camera system is powered off and/or the camera system is powered off. According to some embodiments described herein, in the sleep state an image sensor of the camera system is powered on and is not actively sampling images, and a memory of the camera system is powered on. According to some embodiments described herein, in the active state a memory of the camera system is powered on and is actively storing images from an image sensor in the memory.

### BRIEF DESCRIPTION OF THE FIGURES

These and other features, aspects, and advantages of the present disclosure are better understood when the following Detailed Description is read with reference to the accompanying drawings.

FIG. 1 illustrates an example block diagram of a camera system according to some embodiments described herein.

FIG. 2 illustrates an example state diagram of different power consumption modes of a camera system according to some embodiments described herein.

FIG. 3 is an example flowchart of a process for transitioning between power consumption modes according to some embodiments described herein.

FIG. 4 is an example flowchart of a process for transitioning between power consumption modes according to some embodiments described herein.

FIG. 5A is an example diagram of the camera system positioned outside a circular proximity zone according to some embodiments described herein.

FIG. 5B illustrates the camera system positioned within the circular a proximity zone such according to some embodiments described herein.

FIG. 6A is an example diagram of the camera system positioned outside a rectangular proximity zone according to some embodiments described herein.

FIG. 6B illustrates the camera system positioned within the rectangular proximity zone according to some embodiments described herein.

FIG. 7 is an example flowchart of a process for transitioning between power consumption modes according to some embodiments described herein.

FIG. 8 is an example flowchart of a process for prioritizing the transfer of data according to some embodiments described herein.

FIG. 9 shows an illustrative computational system for performing functionality to facilitate implementation of embodiments described herein.

### DETAILED DESCRIPTION

According to embodiments described herein, a domain aware camera system is disclosed that may perform any number of functions based on proximity data and/or motion data. For example, in some embodiments, a camera system may transition between a hibernate state, a sleep state, and/or an active state based on motion data and/or proximity data. Motion data, for example, may be recorded by a motion sensor 135 that may include an accelerometer, a gyroscope, and/or a magnetometer. The proximity data, for example, may be recorded based on data received from a global positioning device and/or a Bluetooth transceiver.

As another example, in some embodiments, a camera system may be in a hibernate state and awoken into a sleep state and/or an active state based on the motion of the camera system as recorded by motion data. Once awoken, the camera system may determine whether it is within proximity of a data hub based on data received by a Bluetooth transceiver and/or a global positioning device. If the camera system is within proximity of the data hub, then the camera system may turn on a dormant Wi-Fi transceiver and may transfer images and/or video to the data hub.

Various other embodiments and examples are described herein.

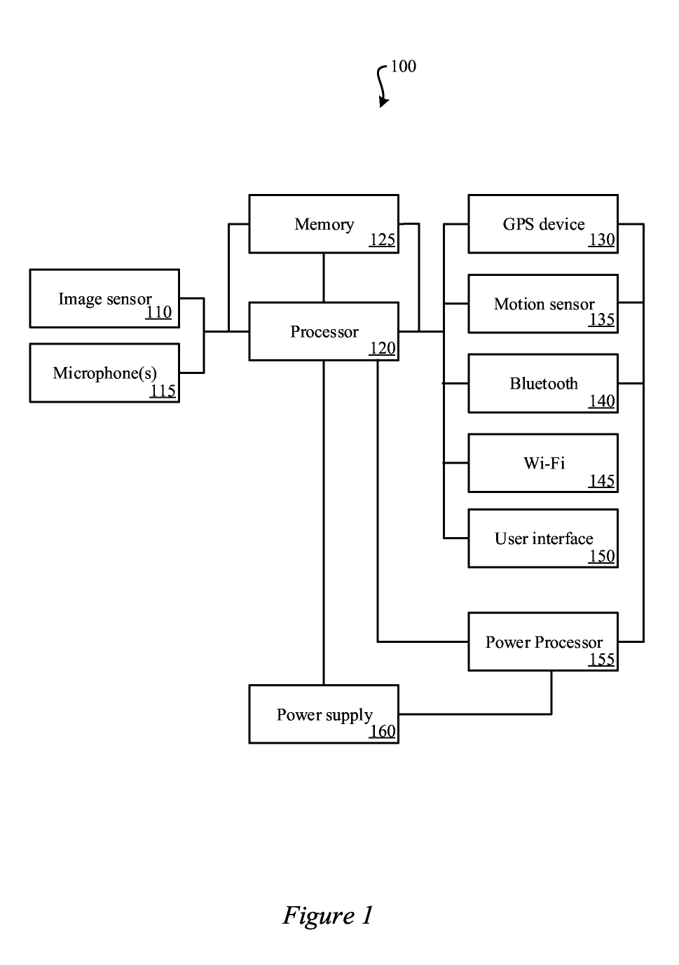

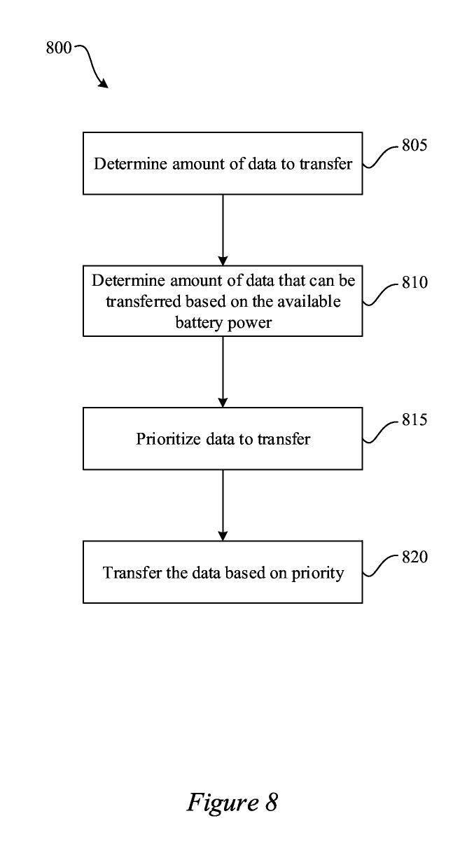

FIG. 1 illustrates an example camera system 100 according to some embodiments described herein. The camera system 100 includes an image sensor 110, a microphone 115, a processor 120, a memory 125, a global positioning system (GPS) device 130, a motion sensor 135, a Bluetooth transceiver 140, and/or a Wi-Fi transceiver 145. The camera system may also include a power processor 155 and/or a power supply 160. The processor 120 may include any type of controller or logic. For example, the processor 120 may include all or any of the components of computational system 800 shown in FIG. 8.

The image sensor 110 may include any image sensor known in the art that records digital video of any aspect ratio, size, and/or frame rate. The image sensor 110 may include an image sensor that samples and records a field of view. The image sensor, for example, may include a CCD or a CMOS sensor. For example, the aspect ratio of the digital video produced by the image sensor 110 may be 1:1, 4:3, 5:4, 3:2, 16:9, 10:7, 6:5, 9:4, 17:6, etc., or any other aspect ratio. As another example, the size of the image sensor 110 may be 8 megapixels, 15 megapixels, 20 megapixels, 50 megapixels, 100 megapixels, 200 megapixels, 500 megapixels, 1000 megapixels, etc., or any other size. As another example, the frame rate may be 24 frames per second (fps), 25 fps, 30 fps, 48 fps, 50 fps, 72 fps, 120 fps, 300 fps, etc., or any other frame rate. The frame rate may be an interlaced or progressive format. Moreover, the image sensor 110 may also, for example, record 3-D video. The image sensor 110 may provide raw or compressed video data. The video data provided by the image sensor 110 may include a series of video frames linked together in time. Video data may be saved directly or indirectly into the memory 125.

The microphone 115 may include one or more microphones for collecting audio. The audio may be recorded as mono, stereo, surround sound (any number of channels), Dolby, etc., or any other audio format. Moreover, the audio may be compressed, encoded, filtered, compressed, etc. The audio data may be saved directly or indirectly into the memory 125. The audio data may also, for example, include any number of channels. For example, for stereo audio, two channels may be used. And, for example, surround sound 5.1 audio may include six channels.

The processor 120 may be a central processor and/or may be communicatively coupled with the image sensor 110 and the microphone 115 and/or may control the operation of the image sensor 110 and the microphone 115. The processor 120 may also perform various types of processing, filtering, compression, etc. of video data and/or audio data prior to storing the video data and/or audio data into the memory 125.

The memory 125 may include, for example, RAM memory and/or flash memory.

The GPS device 130 may be communicatively coupled with the processor 120 and/or the memory 125. The GPS device 130 may include a sensor that may collect GPS data. In some embodiments, the GPS data may be sampled and saved into the memory 125 at the same rate as the video frames are saved. Any type of GPS device 130 may be used. GPS data may include, for example, the latitude, the longitude, the altitude, a time of the fix with the satellites, a number representing the number of satellites used to determine GPS data, the bearing, and speed. The GPS device 130 may record GPS data into the memory 125. For example, the GPS device 130 may sample GPS data at any rate.

The motion sensor 135 may be communicatively coupled with the processor 120 and/or the memory 125. The motion sensor 135 may record motion data into the memory 125. The motion data may be sampled and saved into the memory 125. The motion sensor 135 may, for example, include any type of telemetry sensor. Furthermore, the motion sensor 135 may include, for example, an accelerometer, a gyroscope, and/or a magnetometer. The motion sensor 135 may include, for example, a nine-axis sensor that outputs raw data in three axes for each of three individual sensors: accelerometer, gyroscope, and magnetometer, or it can output a rotation matrix that describes the rotation of the sensor about the three Cartesian axes. Moreover, the motion sensor 135 may also provide acceleration data. The motion sensor 135 may be sampled and the motion data saved into the memory 125.

In some embodiments, the motion sensor 135 may include a motion processor that is coupled with an accelerometer, a gyroscope, and/or a magnetometer. The motion processor may collect the raw data from the accelerometer, gyroscope, and/or magnetometer and output processed data from the sensors. In some embodiments, in a low power mode of the motion sensor 135, the motion processor may sample data at predetermined periods of time and output data when a motion event occurs such as, for example, when the data is above a threshold. In some embodiments, the motion sensor 135 does not send any data until an event happens.

Alternatively, the motion sensor 135 may include separate sensors such as a separate one- or two-axis accelerometer, a gyroscope, and/or a magnetometer. The raw data from these sensors may be saved in the memory 125 as motion data.

Moreover, the motion sensor 135 may output raw or processed motion data.

The Bluetooth transceiver 140 may include a Bluetooth antenna, control logic, and/or the memory 125. The Bluetooth transceiver 140 may include any other type of Bluetooth components, and/or may be used to communicate with other Bluetooth-enabled devices. For example, the Bluetooth transceiver may include Bluetooth low energy (Bluetooth LE, BTLE, or BLE) and/or Bluetooth Smart components that operate with lower energy consumption. The Bluetooth transceiver 140 may communicate with various other Bluetooth-enabled devices such as the data hub. Data may be transmitted wirelessly, for example, between the camera system 100 and the data hub via using the Bluetooth transceiver 140.

The data hub, for example, may be any type of computer or processing system that may transmit and/or receive data from a camera system 100, for example, using Wi-Fi. In some embodiments, the camera system 100 may transmit photos and/or videos recorded by the camera system 100 to the data hub 500 when within proximity with the data hub 500. The data hub 500, for example, may include a Wi-Fi transceiver, Bluetooth connectivity, and/or data storage. The data storage may include cloud storage, memory, a hard drive, a server, etc.

In some embodiments, the Bluetooth transceiver 140 may perform proximity detection with other devices such as, for example, the data hub. Proximity detection, for example, may determine when the camera system 100 is close to the data hub or within the Bluetooth zone. For example, proximity may be estimated using the radio receiver's received signal strength indication (RSSI) value, for example, when the RSSI is greater than a threshold value. As described in more detail below, various events may be triggered or not triggered when the distance between the devices exceeds a set threshold.

The Wi-Fi transceiver 145 may include one or more Wi-Fi antennas, Wi-Fi logic, and/or the memory 125. The Wi-Fi transceiver 145 may be used to communicate wirelessly with a Wi-Fi modem or router coupled with the data hub. Any type of Wi-Fi transceiver 145 or Wi-Fi components may be used. In some embodiments, the Wi-Fi transceiver 145, for example, may be used to transmit and/or receive data between the camera system 100 and a data hub.

A user interface 150 may include any type of input/output device including buttons, a keyboard, a screen, and/or a touchscreen. The user interface 150 may be communicatively coupled with the processor 120 and/or the memory 125 via wired or wireless interface. The user interface 150 may provide instructions from the user and/or output data to the user. Various user inputs may be saved in the memory 125. For example, the user may control the operation of the camera system such as, for example, recording video, playing back video, zooming in, zooming out, deleting video in the memory 125, editing video in the memory 125, transferring and/or receiving video or images from the memory 125 to an external device, etc.

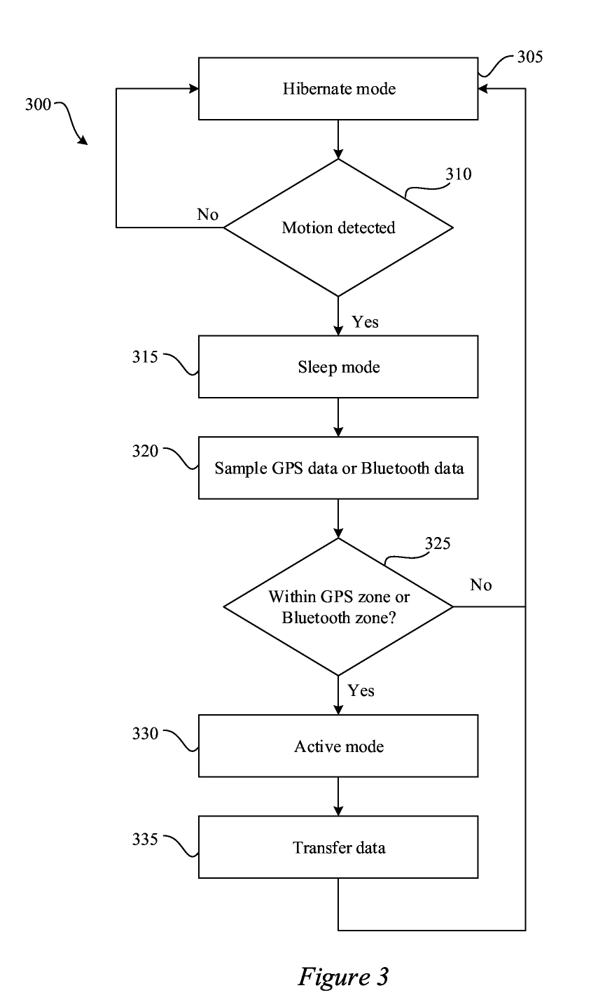

The power processor 155 may include any type of processor, controller, or logic. The power processor 155 may perform various power management functions according to some embodiments described herein. For example, such power management functions may include all or parts of processes 300, 400, 500, and 700 described in FIGS. 3, 4, 5, and 7, respectively.

In some embodiments, the power processor 155 may perform various motion detection functions. For example, the power processor 155 may determine whether certain types of motion have occurred based on data received from either or both the GPS device 130 and/or the motion sensor 135. For example, the power processor 155 may determine whether the camera system 100 was picked up, moved, rotated, dropped, etc. In some embodiments, the power processor 155 may also determine whether the camera system 100 has been moved within a Bluetooth zone and/or a GPS zone based on motion data and/or GPS data.

In some embodiments, a separate motion processor may be used to perform various motion detection functions. For example, the motion processor may be coupled with either or both of the GPS device 130 and/or the motion sensor 135. As another example, a motion processor may be integrated with either or both of the GPS device 130 and/or the motion sensor 135. During hibernate mode, the motion processor may send a wake up signal to the processor 120 when a motion event occurs and/or send not data unless or until the event occurs.

The power supply 160 may include a battery power source of any type. For example, the battery power source may be a removable and/or rechargeable battery. Power to various components may be managed by either or both the power processor 155 and/or the processor 120 based on various activities, motions, user inputs, and/or locations.

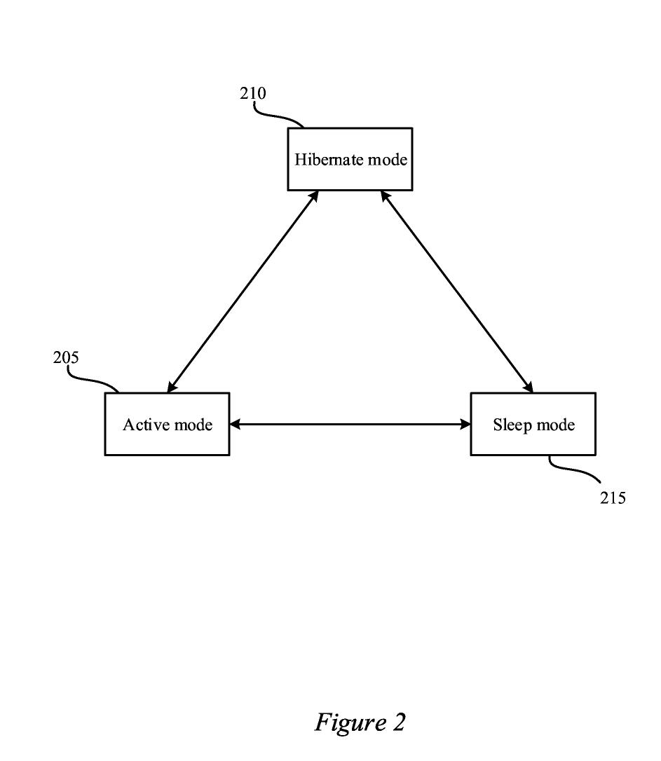

In some embodiments, as shown in the state diagram of FIG. 2, the camera system 100 may have many different power consumption modes such as a sleep mode 215, a hibernate mode 210, and an active mode 205. In the active mode 205, the image sensor and/or many of the components may function in an active state. For example, the image sensor 110 may be actively capturing images and/or video and/or the camera system 100 may be sending and/or receiving data from a data hub, for example, via the Wi-Fi transceiver 145 and/or the Bluetooth transceiver 140. The GPS device 130 and the motion sensor 135, for example, may also be active and may be available to sample and/or store data in the memory 125. In some embodiments, the Bluetooth transceiver 140 and/or the Wi-Fi transceiver 145 may be turned off by the user, for example, via the user interface 150, in the active mode 205.

In the sleep mode 215, for example, some or all of the memory 125 (e.g., RAM) may be refreshed and placed in a minimum power state. In some embodiments, the machine state of the processor 120 may be held in portions of the memory 125 (e.g., flash). In some embodiments, during the sleep mode 215 the GPS device 130, the motion sensor 135, the Bluetooth transceiver 140, the Wi-Fi transceiver 145, and/or the user interface 150 may be placed in a lower power state or turned off. Moreover, in some embodiments, during the sleep mode 215 the image sensor 110 and/or the microphone 115 may be placed in a lower power state. For example, the image sensor 110 may be turned on but may not be actively sampling data. As another example, less than 10 mA, 5 mA, 2 mA, 1 mA, etc. may be drawn from the power supply 160.

In the hibernate mode 210 the camera system 100 may be in its lowest energy state other than complete power down. For example, the current image from the image sensor in the image sensor 110 may be stored in the memory 125 (e.g., flash) prior to entering the hibernate mode 210. In the hibernate mode 210, for example, less than 500 μA, 200 μA, 100 μA, 50 μA, etc. may be drawn from the power supply 160. In the hibernate mode 210, all or portions of the Bluetooth transceiver 140, all or portions of the power processor 155, all or portions of the user interface 150, all or portions of the GPS device 130, and/or all or portions of the motion sensor 135 may be active or active for certain periods of time. In the hibernate mode 210, for example, the image sensor 110 may be powered off.

As described in more detail below, the camera system 100 may transition between power consumption modes in response to any number of events. In some embodiments, the camera system 100 may transition from the hibernate mode 210 to the sleep mode 215 when it is predicted that the camera system may be used in the near future. For example, the camera system 100 may transition from the hibernate mode 210 to the sleep mode 215 in response to motion triggers based on motion data received from the motion sensor 135 that indicates that the camera system 100 has been moved or picked up in preparation for use. The motion triggers may include, for example, one or more of the following triggers motion data over a specified value, a combination of motion data, a sequence of motion data, motion data coupled with other sensor data, audio data recorded from a microphone, GPS data, altimeter data, temperature data, auxiliary sensor data, etc.

The camera system 100 may transition from the sleep mode 215 to the hibernate mode 210 after the camera system 100 has been in the sleep mode 215 for a specified period of time and no motion has been detected based on the motion data.

The camera system 100 may transition from the sleep mode 215 to the active mode 205, for example, in response to a specific input from the user interface 150 that indicates that the camera system 100 is being put into use, for example, when the user selects a record button, a play button, a tag button, a photo/burst photo button, etc. In some embodiments, buttons on the user interface may be multifunction buttons, for example, a single slider with an integrated push function to facilitate: photo/burst, video record, photo/burst while recording, and tag while recording. Default behavior of any of the buttons may be modified through preferences.

The camera system 100 may also transition from the sleep mode 215 to the active mode 205, for example, in response to Bluetooth data that indicates that the camera system 100 is within a selected radius of a data hub based on a proximity detection function. The camera system 100 may also transition from the sleep mode 215 to the active mode 205, for example, in response to GPS data that indicates that the camera system 100 is within a selected radius of a data hub or within a geographical location defined by a geo-fence surrounding the data hub. Various other triggers may be used to transition from the sleep mode 215 to the active mode 205.

In some embodiments, the camera system 100 may transition from the active mode 205 to the sleep mode 215 when the image sensor 110 is no longer capturing images and/or video and/or when data is no longer being transmitted and/or received from the data hub.

In some embodiments, the camera system 100 may transition from the hibernate mode 210 to the active mode 205 in response to user input through the user interface 150 and/or when the camera system 100 enters a Bluetooth zone and/or a GPS zone.

The following tables show example states of various components of the camera system 100 while in the hibernate mode 210, the sleep mode 215, and/or the active mode 205 according to some embodiments described herein. In some embodiments, the motion sensor 135 may be in a low power mode when the camera system 100 is in the hibernate state. In the low power mode, a motion processor of the motion sensor 135 may sample motion data at selected intervals and send a signal to the processor to transition from the hibernate mode 210 to the sleep mode 215 when some measure of motion occurs or has occurred such as, for example, acceleration above a threshold, a specific motion, a specific rotation, etc. The selected intervals may be, for example, less than 1,000, 500, 250, 100, 50, 10 or 1 microsecond. In this way, for example, the camera system 100 may transition states based on motion of the camera system 100 yet do so with lower power consumption.

| | Hibernate | Sleep | Active |
|---|---|---|---|
| Image sensor | Off | Off | On and actively |
| | | | sampling images |
| Camera system | <100 μA | <2 mA | >2 mA |
| power consumption | | | |
| Wi-Fi | Off | Off | On, if needed |
| Memory | Off | Deep sleep | On |
| | | mode | |
| Motion sensor 135 | Low power mode | On | On |
| GPS device | Off | Off | On |
| Processor | Off | On | On |

The following table shows example states of various components of the camera system 100 while in the hibernate state, the sleep state, and the active state according to some embodiments described herein. In some embodiments, the GPS device may be in a low power mode when the camera system 100 is in the hibernate state. In the low power mode, a motion processor of the GPS device may sample GPS data at selected intervals and send a signal to the processor to transition from the hibernate mode 210 to the sleep mode 215 when the camera system 100 has moved near or within specific GPS coordinates, or moved a specific distance The selected intervals may be, for example, less than 10,000, 1,000, 500, 250, 100, 50, 10 or 1 microsecond. In this way, for example, the camera system 100 may transition states based on the location of the camera system 100 yet do so with lower power consumption.

| | Hibernate | Sleep | Active |
|---|---|---|---|
| Image sensor | Off | Off | On and actively |
| | | | sampling images |
| Camera system | <100 μA | <2 mA | >2 mA |
| power consumption | | | |
| Wi-Fi | Off | Off | On, if needed |
| Memory | Off | Deep sleep | On |
| | | mode | |
| Motion sensor 135 | Off | On | On |
| GPS device | Low power mode | On | On |
| Processor | Off | On | On |

The following table shows example states of various components of the camera system 100 while in the hibernate state, the sleep state, and the active state according to some embodiments described herein. In this embodiment, the power processor 155 is used to manage transitions between the various states. GPS data and/or motion data may be used by the power processor 155 to transition the camera system 100 between the various states.

| | Hibernate | Sleep | Active |
|---|---|---|---|
| Image sensor | Off | Off | On and actively |
| | | | sampling images |
| Camera system | <100 μA | <2 mA | >2 mA |
| power consumption | | | |
| Wi-Fi | Off | Off | On, if needed |
| Memory | Off | Deep sleep | On |
| | | mode | |
| Motion sensor 135 | Low power mode | On | On |
| GPS | Low power mode | On | On |
| Processor | Off | On | On |
| Power processor | On | On | On |

In some embodiments, plugging in the camera system 100 to a different and/or stable power source may automatically transition the camera system to the sleep mode 215 and/or the active mode 205. In some embodiments, the Wi-Fi, GPS, and/or motion sensor 135 may be turned on when the camera system is plugged in.

FIG. 3 is an example flowchart of a process 300 for transitioning between power consumption modes according to some embodiments described herein. The process 300 starts at block 305 where the camera system 100 is in the hibernate mode as described above. At block 310, the process 300 determines whether motion has been detected. If motion has not been detected, then the process 300 remains at block 305. Motion may be detected, for example, by monitoring motion data sampled from the motion sensor 135. For instance, changes in motion above a threshold may indicate motion. In some embodiments, the power process 155 may monitor motion data sampled from the motion sensor 135 to determine whether motion has been detected. In some embodiments, the camera system 100 may periodically detect whether motion has been detected from sample motion data.

If motion has been detected at block 310, then the process 300 proceeds to block 315 and the camera system 100 enters the sleep mode as described above. At block 320 the camera system may sample GPS data from the GPS device 130 and/or Bluetooth data from the Bluetooth transceiver 140. At block 325, the process 300 determines whether the camera system 100 is within a proximity zone relative to a computer or data center. The proximity of the camera, for example, may be based on the relative signal strength of the Bluetooth signal.

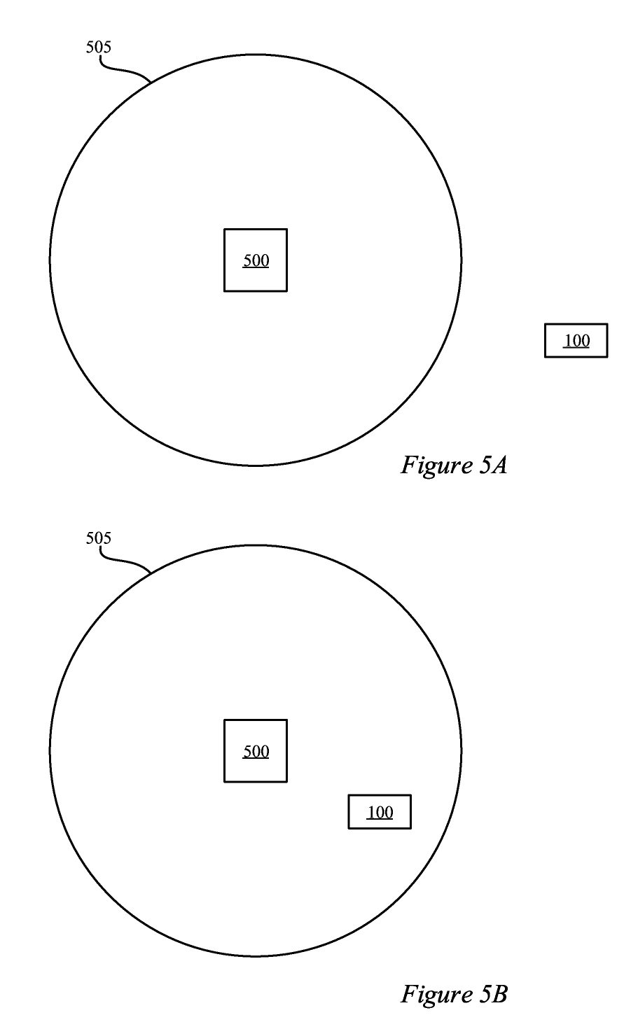

FIG. 5A is an example diagram of the camera system 100 positioned outside a circular proximity zone 505 according to some embodiments described herein. The circular proximity zone 505, for example, may be centered on the data hub 500. The circular proximity zone 505, for example, may circumscribe a distance around the data hub 500 that is proportional to the distance the Bluetooth transceiver 140 can detect proximity with the data hub 500. For example, if the Bluetooth transceiver 140 can detect proximity up to three meters then the circular proximity zone 505 may be a circle centered on the data hub 500 with a radius of three meters. The circular proximity zone 505 may alternately be centered on a specific GPS location with a radius proportional with the Wi-Fi connectivity radius around the data hub 500. The circular proximity zone 505 may be, for example, 1, 5, 10, 15, 20, 25, 30, 35, 40, 45, 50, 55, 60, 65, 70, 75, 80, etc. feet in diameter.

FIG. 5B illustrates the camera system 100 positioned within the circular proximity zone 505 such that within the circular proximity zone 505 the camera system 100 detects proximity relative to the data hub 500. Once within the circular proximity zone 505 the camera system 100 may be within close enough proximity with the data hub 500 to transmit or receive data over Wi-Fi using Wi-Fi transceiver 145.

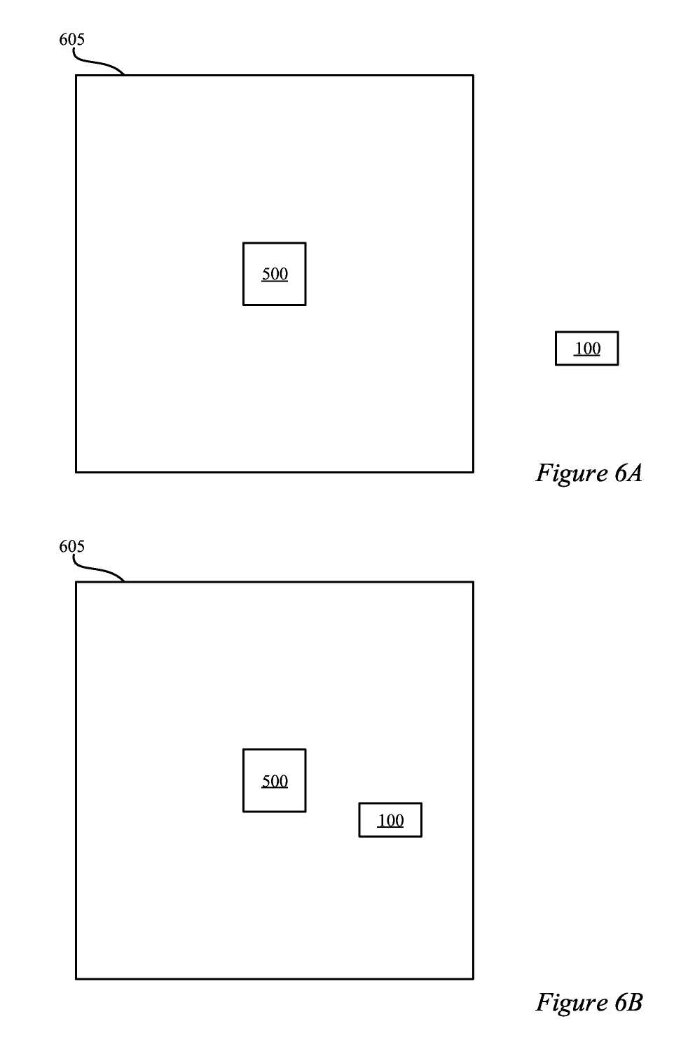

FIG. 6A is an example diagram of the camera system 100 positioned outside a rectangular proximity zone 605 according to some embodiments described herein. The rectangular proximity zone 605, for example, may be bounded by GPS coordinates that define a rectangular zone within which data may be transmitted and/or received via Wi-Fi to the data hub 500. FIG. 6B illustrates the camera system 100 positioned within the rectangular proximity zone 605. The rectangular proximity zone 605, for example, may comprise any shape or size. The rectangular proximity zone 605 may be considered a geo-fence defined by GPS coordinates.

Returning to FIG. 3, if the camera system 100 determines that it is located within a proximity zone at block 325, then the process 300 proceeds to block 330 where the camera system 100 enters the active mode. At block 330 data such as, for example, photos, videos, and/or metadata may be transmitted to the data hub. Once data has been transferred to the data hub, then the process 300 may return to block 305, the camera system 100 may enter hibernate mode, and the process 300 may repeat.

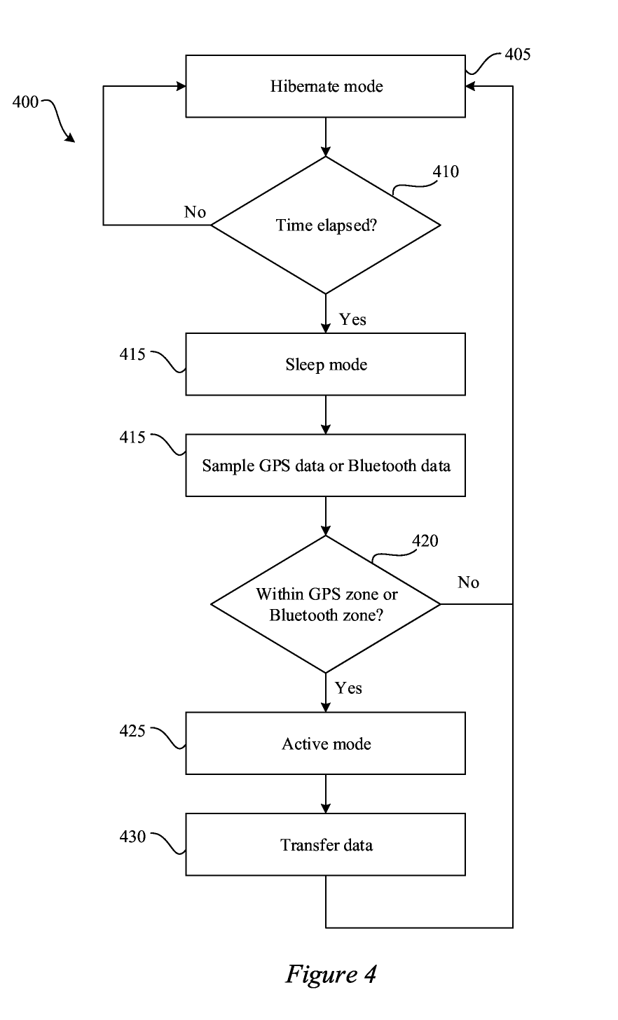

FIG. 4 is an example flowchart of a process 400 for transitioning between power consumption modes according to some embodiments described herein. The process 400 starts at block 405 where the camera system 100 is in the hibernate mode as described above. At block 410, the process 400 determines whether a predetermined or selected period of time has elapsed. The predetermined or selected period of time may include any period of time such as, for example, 30 seconds, one minute, ten minutes, 30 minutes, one hour, four hours, six hours, etc. If the predetermined or selected period of time has not elapsed, then the process 400 returns to the hibernate mode at block 405.

If the predetermined or selected period of time has elapsed, then the camera system 100 enters the sleep mode at block 415. In the sleep mode at least GPS data from the GPS device 130 and/or Bluetooth data from the Bluetooth device 140 may be sampled at block 415. At block 420 the sampled data may be used to determine whether the camera system 100 is within a proximity zone (e.g., a GPS zone or Bluetooth zone) by comparing the sampled data with predetermined proximity zone data.

If the camera system 100 is not within a proximity zone, then the process 400 returns to block 405. If the camera system 100 is within the proximity zone, then data may be transferred to and/or from the camera system 100 with the data hub 500. Once the data has been transferred, the process 400 may return to block 405.

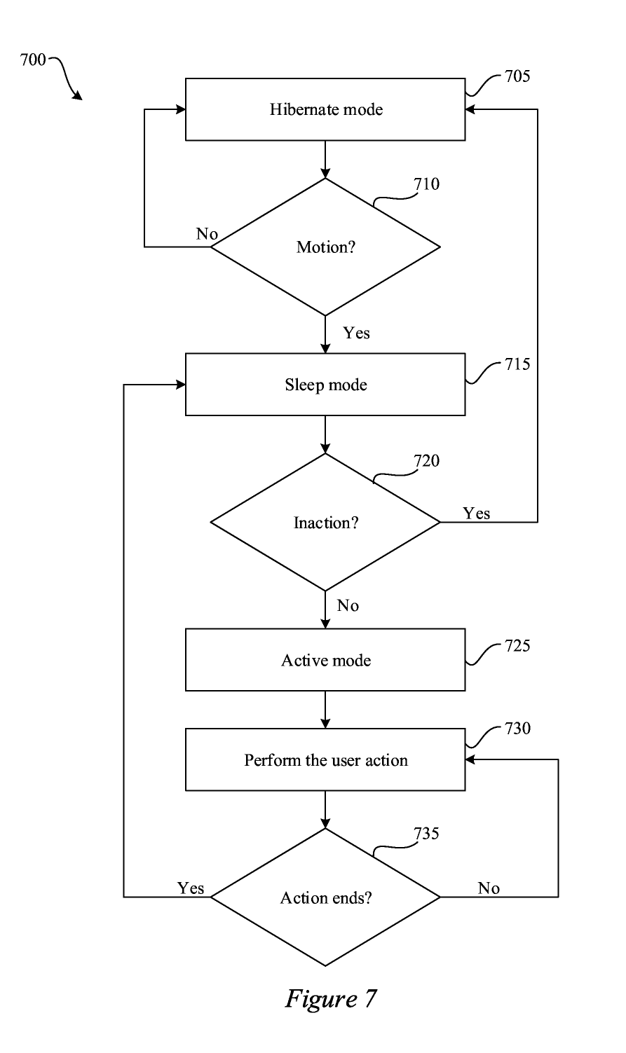

FIG. 7 is an example flowchart of a process 700 for transitioning between power consumption modes according to some embodiments described herein. The process 700 starts at block 705 where the camera system 100 is in the hibernate mode as described above. At block 710, the process 700 determines whether a motion has been detected. For example, the power processor 155 (or another processor) may sample data from the motion sensor 135 to determine if the sampled motion data is above a threshold. For example, motion data may indicate an upward acceleration above 1G indicating that the camera system 100 has been picked up from a resting position. As another example, motion data may indicate that the camera system 100 has been rotated from a vertical orientation into a horizontal orientation indicating that the user may be positioning the camera system prior to recording images and/or data. Various other motion data sequences or motion data values may be sufficient to indicate motion. Alternatively or additionally, the power processor 155 may sample data from the GPS device 130 to determine whether a motion has been detected.

If no motion has been detected, then the process 700 returns to block 705. And motion detection can occur again, possibly after a period of time has elapsed. If motion has been detected, then the process 700 proceeds to block 715. At block 715, the camera system 100 may enter the sleep mode 215. In the sleep mode 215 the camera system 100 may be prepared to capture images and/or video.

While in the sleep mode the camera system 100 may be ready to record and save images and/or video in response to some indication or action of the user such as, for example, pressing a record button, pressing a video playback button, pressing an image viewing button, etc. If no user action has been detected at block 720 then the process 700 can return to block 705 and the camera system 100 may return to the hibernate mode 210. If a user action has been detected, the camera system may enter the active mode at block 725 and may then perform the user action at block 730. For example, the image sensor 110 may record an image or a video and save it in the memory 125. As another example, the image sensor 110 may present an image on the user interface 150. Various other user actions may be performed. If the user action has been completed as determined at block 735, then the process 700 may return to block 715 and the camera system 100 may enter sleep mode; otherwise the camera system may continue to perform the user action.

FIG. 8 is an example flowchart of a process 800 for prioritizing the transfer of data according to some embodiments described herein. Process 800 starts at block 805 where the amount of data to be transferred from the camera system 100 to the data hub. The amount of data to be transferred can be determined in any number of ways. For example, the amount of data to be transferred may include all the data since the last transfer. As another example, the amount of data to be transferred may include all the data in a certain file location or a folder.

At block 810, the amount of data that can be transferred may be determined, for example, based on the available battery power. For example, if the battery only contains 10% battery power, and it takes 1% of battery power to transfer 100 megabytes, then only 1 gigabyte can be transferred. The amount or the percentage of battery power that is used to transfer data may be determined based on previous data transfers

At block 815, if the amount of data that can be transferred is less than the amount of data to be transferred, then the data may be prioritized. In some embodiments, the data may be prioritized regardless. The data may be prioritized in any number of ways such as, for example, the time the data was recorded, metadata associated with a video, the length of a video, the image quality of the video, the type of video, whether the video includes voice tags, whether the video includes an audio track, people tags, excitement score, relevance score, or any other measure, etc. Various other metadata may be used, for example, as disclosed in U.S. patent application Ser. No. 14/143,335 titled Video Metadata and filed Dec. 30, 2013, the entirety of which is incorporated herein without limitation for all purposes.

At block 820, the data may be transferred based on the priority of the data. Thus, the highest priority data is transferred to the data hub.

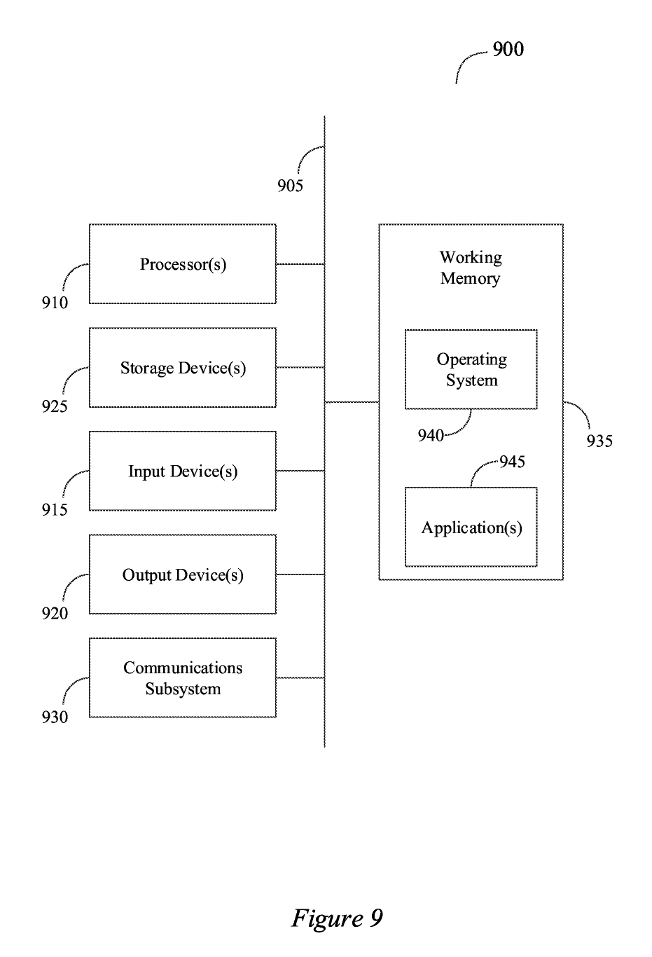

A computational system 900 (or processing unit) illustrated in FIG. 9 can be used to perform any of the embodiments of the invention. For example, the computational system 900 can be used alone or in conjunction with other components to execute all or parts of the processes 300, 400, 700 and/or 800. As another example, the computational system 900 can be used to perform any calculation, solve any equation, perform any identification, and/or make any determination described here. The computational system 900 includes hardware elements that can be electrically coupled via a bus 905 (or may otherwise be in communication, as appropriate). The hardware elements can include one or more processors 910, including, without limitation, one or more general purpose processors and/or one or more special purpose processors (such as digital signal processing chips, graphics acceleration chips, and/or the like); one or more input devices 915, which can include, without limitation, a mouse, a keyboard, and/or the like; and one or more output devices 920, which can include, without limitation, a display device, a printer, and/or the like.

The computational system 900 may further include (and/or be in communication with) one or more storage devices 925, which can include, without limitation, local and/or network-accessible storage and/or can include, without limitation, a disk drive, a drive array, an optical storage device, a solid-state storage device, such as the random access memory 125 (“RAM”) and/or the read-only memory 125 (“ROM”), which can be programmable, flash-updateable, and/or the like. The computational system 900 might also include a communications subsystem 930, which can include, without limitation, a modem, a network card (wireless or wired), an infrared communication device, a wireless communication device, and/or chipset (such as a Bluetooth transceiver 140, an 902.6 device, a Wi-Fi device, a WiMax device, cellular communication facilities, etc.), and/or the like. The communications subsystem 930 may permit data to be exchanged with a network (such as the network described below, to name one example) and/or any other devices described herein. In many embodiments, the computational system 900 will further include a working memory 125, which can include a RAM or ROM device, as described above.

The computational system 900 also can include software elements, shown as being currently located within the working memory 125, including an operating system 940 and/or other code, such as one or more application programs 945, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 925 described above.

In some cases, the storage medium might be incorporated within the computational system 900 or in communication with the computational system 900. In other embodiments, the storage medium might be separate from the computational system 900 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory 125, such as a computer memory 125. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A method for managing power with a camera system, the method comprising:
receiving at a processor motion data from a motion sensor 135 while in a hibernate state;
determining, at the processor, whether the motion data indicates motion of the camera system;
in the event the motion data indicates motion of the camera system, entering a sleep state;
receiving a user input while in the sleep state; and
entering an active state such that an image sensor of the camera system is powered on and is actively sampling images.

2. The method according to claim 1, wherein in the hibernate state an image sensor of the camera system is powered off; and in the hibernate state a memory of the camera system is powered off.

3. The method according to claim 1, wherein in the sleep state a memory of the camera system is powered on.

4. The method according to claim 1, wherein the determining whether the motion data indicates motion of the camera system further comprises determining whether the motion data exceeds a threshold value.

5. The method according to claim 1, in the event the motion data indicates motion of the camera system, sending an indication to enter a sleep state to a central processor, wherein the central processor is different than the processor.

6. The method according to claim 1, wherein the motion data comprises acceleration data.

7. A camera system comprising:
a motion sensor 135;
an image sensor;
a user interface;
a memory; and
a processor communicatively coupled with at least the motion sensor 135 and the user interface, the processor configured to:
enter a hibernate state;
receive motion data from the motion sensor 135;
determine whether the motion data indicates motion of the camera system;
in the event motion is determined from the motion data, entering a sleep state;
receive a user input from the user interface while in the sleep state; and
entering an active state such that an image sensor of the camera system is powered on and is actively sampling images.

8. The camera system according to claim 7, wherein in the hibernate state the image sensor is powered off; and in the hibernate state the memory is powered off.

9. The camera system according to claim 7, wherein the motion sensor 135 comprises at least a motion sensor 135 selected from the list consisting of an accelerometer, a gyroscope, and a magnetometer.

10. The camera system according to claim 7, wherein the processor comprises a central processor and a motion processor, wherein in the event motion is determined from the motion data the motion processor sends an indication to the central processor to enter a sleep state, wherein the central processor is different than the motion processor.

11. A method for managing communication in a camera system, the method comprising:
turning off a Wi-Fi transceiver;
receiving, at a processor, global positioning data from a global positioning device;
determining, at the processor, whether the global positioning data indicates that the camera system is positioned within a geo-fence;
in the event the global positioning data indicates that the camera system is positioned within a geo-fence, turning on the Wi-Fi transceiver; and
transferring images or video from the camera system to the data hub via Wi-Fi.

12. The method according to claim 11, wherein the geo-fence bounds a geographical location within which the camera system can communicate with the data hub via Wi-Fi.

13. The method according to claim 11, wherein the geo-fence is a geographical location bounded by a plurality of global positioning coordinates.

14. The method according to claim 11, further comprising waiting a predetermined period of time before receiving global positioning data from a global positioning device.

15. The method according to claim 11, further comprising:
receiving, at the processor, motion data from a motion sensor 135; and
determining, at the processor, whether the motion data indicates motion of the camera system.

16. A camera system comprising:
a global positioning device;
an image sensor;
a Wi-Fi transceiver; and
a processor communicatively coupled with at least the global positioning device and the Wi-Fi transceiver, the processor configured to:
turn off the Wi-Fi transceiver;
receive global positioning data from the global positioning device;
determine whether the global positioning data indicates that the camera system is positioned within a geo-fence;
in the event the global positioning data indicates that the camera system is positioned within a geo-fence, turn on the Wi-Fi transceiver; and
transfer images or video stored in the memory to a data hub using the Wi-Fi transceiver.

17. The camera system according to claim 16, wherein the geo-fence bounds a geographical location within which the camera system can communicate with the data hub via Wi-Fi.

18. The camera system according to claim 16, further comprising a motion sensor 135, wherein the processor is further configured to:
receive motion data from the motion sensor 135; and
determine whether the motion data indicates motion of the camera system.

19. A method for managing communication in a camera system, the method comprising:
turning off a Wi-Fi transceiver;
receiving, at a processor, Bluetooth signal data from a Bluetooth transceiver;
determining, at the processor, whether the Bluetooth signal indicates that the camera system is within a selected proximity of a data hub;
in the event the Bluetooth signal indicates that the camera system is within a selected proximity of a data hub, turning on the Wi-Fi transceiver; and
transferring images or video from the camera system to the data hub via Wi-Fi.

20. The method according to claim 19, wherein determining whether the Bluetooth signal indicates that the camera system is within a selected proximity of a data hub further comprises determining whether a received signal strength is above a threshold.

21. A camera system comprising:
a Bluetooth transceiver;
an image sensor;
a Wi-Fi transceiver; and
a processor communicatively coupled with at least the Bluetooth transceiver, the image sensor, and the Wi-Fi transceiver, the processor configured to:
turn off the Wi-Fi transceiver;
receive a Bluetooth signal data from the Bluetooth transceiver;
determine whether the Bluetooth signal indicates that the camera system is within a selected proximity of a data hub;
in the event the Bluetooth signal indicates that the camera system is within a selected proximity of a data hub, turn on the Wi-Fi transceiver; and
transfer images or video to the data hub using the Wi-Fi transceiver.

22. The camera system according to claim 21, wherein the processor is further configured to:
determine whether the Bluetooth signal indicates that the camera system is within a selected proximity of a data hub;
determine whether a received signal strength is above a threshold.

23. A method occurring at a camera system, the method comprising:
receiving, at a processor, motion data from a motion sensor 135;
determining, at the processor, whether the motion data indicates motion of the camera system;
receiving proximity data;
determining whether the proximity data indicates that the camera system is positioned within a proximity zone bounding a data hub;
turning on the Wi-Fi transceiver; and
transferring images or video from the camera system to the data hub via Wi-Fi.

24. The method according to claim 23, wherein the proximity data is received from a Bluetooth transceiver and is based on the signal strength of a Bluetooth signal.

25. The method according to claim 23, wherein the proximity data is received from a global positioning device.

26. The method according to claim 23, wherein the proximity zone comprises a geo-fence.

27. A camera system comprising:
a motion sensor 135;
a proximity sensor;
a Wi-Fi transceiver;
an image sensor; and
a processor communicatively coupled with at least the motion sensor 135, the proximity sensor, the image sensor, and the Wi-Fi transceiver, the processor configured to:
receive motion data from the motion sensor 135;
determine whether the motion data indicates motion of the camera system;
receive proximity data from the proximity sensor;
determine whether the proximity data indicates that the camera system is positioned within a proximity zone bounding a data hub;
turn on the Wi-Fi transceiver; and
transfer images or video with the data hub using the Wi-Fi transceiver.

28. The camera system according to claim 27, wherein the proximity sensor is a Bluetooth transceiver and the proximity data comprises Bluetooth data.

29. The camera system according to claim 23, wherein the proximity sensor is a global positioning device and the proximity data is global positioning data.

30. The camera system according to claim 29, wherein the proximity zone comprises a geo-fence.
